(19) United States
(12) Patent Application Publication
(10) Pub. No.: US 2025/0021660 A1
(43) Pub. Date: Jan. 16, 2025

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Tatsuya UEHARA, Kawasaki Kanagawa (JP); Jun KANAI, Inagi Tokyo (JP); Ryuiti KOIKE, Kawasaki Kanagawa (JP); Hayeong SHIN, Yokohama Kanagawa (JP)

(73) Assignee: KABUSHIKI KAISHA TOSHIBA, Tokyo (JP)

(21) Appl. No.: 18/582,961

(22) Filed: Feb. 21, 2024

(30) Foreign Application Priority Data
Jul. 14, 2023 (JP) 2023-115650

(51) Int. Cl. G06F 21/57

(52) U.S. Cl. CPC G06F 21/577; G06F 2221/034

(57) ABSTRACT

According to one embodiment, an information processing device includes one or more processors. The one or more processors are configured to: detect, from a plurality of target components included in an information processing system to be evaluated, one or more of first components affected by a vulnerability included in the information processing system; specify, by using assessment information that associates at least some of the plurality of target components, one or more of assets included in the information processing system, and a degree of impact when the one or more of the assets are attacked, the one or more of the assets corresponding to the detected one or more of the first components; and obtain an evaluation value of damage when the vulnerability is attacked, based on the degree of impact corresponding to the specified one or more of the assets.

### CROSS-REFERENCE TO RELATED APPLICATIONS

This application is based upon and claims the benefit of priority from Japanese Patent Application No. 2023-115650, filed on Jul. 14, 2023; the entire contents of which are incorporated herein by reference.

### FIELD

Embodiments described herein relate generally to an information processing device, an information processing method, and a computer program product.

### BACKGROUND

Various computer-based systems (products) are equipped with software (an example of a component) such as an operating system (OS) and open source software (OSS). These software products consist of a number of components. Even though vulnerabilities are not discovered in these software at the time of system construction or product development, various vulnerabilities may be discovered over time.

Vulnerability information and remedies for such vulnerabilities are provided by intelligence agencies that collect such vulnerabilities or by software vendors themselves. System (product) providers refer to this information and implement patches or workarounds provided by the vendors. Some systems may require detailed notification and planning, such as in situations where a system shutdown is necessary. The providers also require a lot of processing load to verify side effects of the patches or the workarounds. On the other hand, a situation may arise where an excessive processing load is required even though the impact (damage) when a vulnerability is attacked is small. Therefore, the extent of the impact when vulnerabilities are attacked is desirably evaluated in advance.

### BRIEF DESCRIPTION OF THE DRAWINGS

FIG. 1 is a block diagram of an information processing device of a first embodiment;

FIG. 2 is a diagram illustrating an example of the data structure of vulnerability information;

FIG. 3 is a diagram illustrating an example of the data structure of component information;

FIG. 4 is a diagram schematically illustrating the relationship between a plurality of components;

FIG. 5 is a diagram illustrating an example of the data structure of assessment information;

FIG. 6 is a flowchart of an evaluation process in the first embodiment;

FIG. 7 is a flowchart of a component specifying process;

FIG. 8 is a flowchart of AddChild;

FIG. 9 is a flowchart of SearchParent;

FIG. 10 is a flowchart of an evaluation value calculation process;

FIG. 11 is a diagram illustrating an example of a component list;

FIG. 12 is a diagram illustrating an example of a component list;

FIG. 13 is a diagram illustrating an example an evaluation value that is output;

FIG. 14 is a block diagram of an information processing device of a second embodiment;

FIG. 15 is a diagram illustrating an example of the data structure of modification information;

FIG. 16 is a flowchart of an evaluation process in the second embodiment; and

FIG. 17 is a hardware configuration diagram of an information processing device of an embodiment.

### DETAILED DESCRIPTION

In general, according to one embodiment, an information processing device includes one or more processors. The one or more processors are configured to: detect, from a plurality of target components included in an information processing system to be evaluated, one or more of first components affected by a vulnerability included in the information processing system; specify, by using assessment information that associates at least some of the plurality of target components, one or more of assets included in the information processing system, and a degree of impact when the one or more of the assets are attacked, the one or more of the assets corresponding to the detected one or more of the first components; and obtain an evaluation value of damage when the vulnerability is attacked, based on the degree of impact corresponding to the specified one or more of the assets.

Exemplary embodiments of an information processing device will be explained below in detail with reference to the accompanying drawings. The present invention is not limited to the following embodiments.

The information processing device of the embodiment is a device that evaluates the impact (damage) when vulnerabilities specified in an information processing system (a computer system, a computer application product, or the like, hereinafter referred to as target system) to be evaluated are attacked.

As a technique for evaluating the impact of an attack on vulnerabilities, a technique is proposed to calculate the total amount of damage corresponding to vulnerabilities by preparing a database that stores vulnerability information that associates each vulnerability with a corresponding attack, attack information that associates the occurrence rate over a specified period of time with a corresponding risk event for each attack, and risk event information that associates each risk event with an estimated amount of damage. However, such a technique needs to prepare a database by assuming various attacks and risks and considering the correspondence between risk and attack, and risk and amount of damage in advance, resulting in an excessive processing load for evaluating the amount of damage.

The following embodiments use the result of a security risk assessment (hereinafter, simply referred to as risk assessment) that is performed separately for the target system, and evaluate the impact when vulnerabilities in the system are attacked. The risk assessment is a process of clarifying, for example, a damage caused by an attack (threat) on the target system, the magnitude of the damage, the likelihood of attack occurrence, the acceptability of an attack, and the like. In the related art, information (assessment information) resulting from such a risk assessment is not used.

The target system includes a plurality of components (hereinafter referred to as target components). The target component may include one or more hardware components such as a device as well as software. Vulnerabilities in the target system may be software vulnerabilities or hardware vulnerabilities. In the following, a case in which software vulnerabilities are discovered will be mainly explained as an example.

### First Embodiment

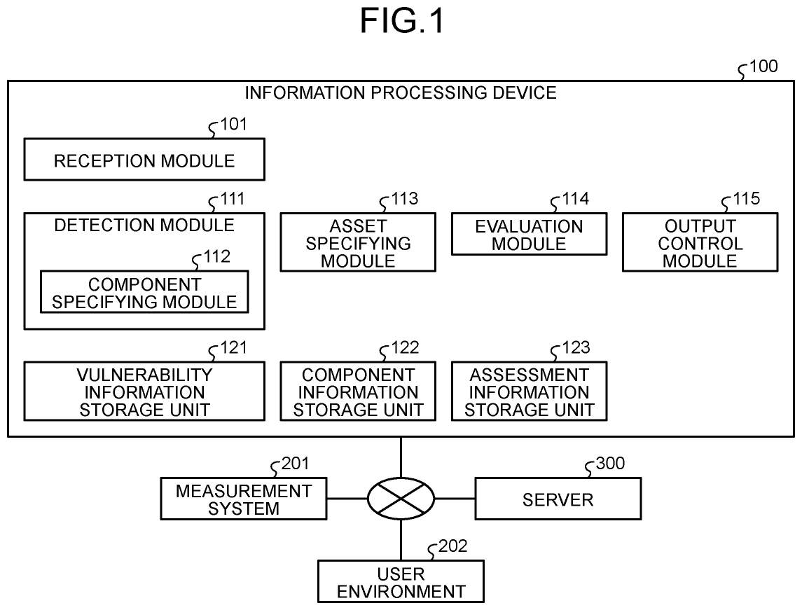

FIG. 1 is a block diagram illustrating an example of the configuration of an information processing device 100 of the first embodiment. As illustrated in FIG. 1, the information processing device 100 is connected to a measurement system 201, a user environment 202, and a server 300 via a network 400.

The measurement system 201 and the user environment 202 are examples of target systems. The measurement system 201 is, for example, a system that collects sensor data measured by sensors or the like. The user environment 202 is, for example, a system for users to use the sensor data measured by the measurement system 201. The target system is not limited to the measurement system 201 and the user environment 202, and may be any system.

The server 300 is a device that collects information on a plurality of software vulnerabilities and provides vulnerability information based on the collected information. The server 300 is operated by, for example, intelligence agencies that collect vulnerabilities or software vendors. For example, the national institute of standards and technology (NIST) maintains a vulnerability information site called a national vulnerability database (NVD), and publishes vulnerability information through this site. The server 300 may be a device managed by such an institution.

The network 400 is, for example, the Internet, and may be any other type of network. The network 400 may be a wired network, a wireless network, or a mixed wired and wireless network.

The information processing device 100 includes a vulnerability information storage unit 121, a component information storage unit 122, an assessment information storage unit 123, a reception module 101, a detection module 111, an asset specifying module 113, an evaluation module 114, and an output control module 115.

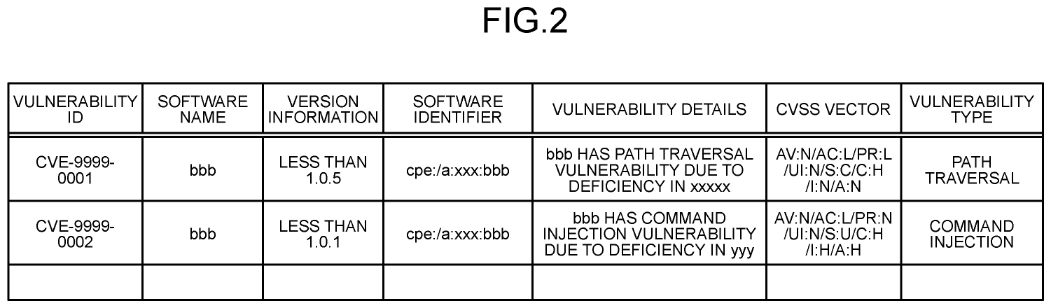

The vulnerability information storage unit 121 stores vulnerability information indicating vulnerabilities collected for one or more software components. The vulnerability information is collected by, for example, the server 300 and transmitted to the information processing device 100. FIG. 2 is a diagram illustrating an example of the data structure of the vulnerability information.

As illustrated in FIG. 2, the vulnerability information includes a vulnerability ID, a software name, version information, a software identifier, vulnerability details, a common vulnerability scoring system (CVSS) vector, and a vulnerability type.

The vulnerability ID is information for uniquely identifying vulnerability information. The vulnerability ID may be a sequential number or the like uniquely assigned within the information processing device 100, or common vulnerabilities and exposures (CVE).

The software name is the name of software that is the subject of the vulnerability information. The version information represents version conditions in which vulnerabilities exist. The version condition may be, for example, a value indicating a relevant version or a range of values indicating the version (for example, “less than 1.0.5”).

The software identifier is information for uniquely identifying the software that is the subject of the vulnerability information. For example, the software identifier may be common platform enumeration (CPE) defined by the NIST, or any other form.

The vulnerability details represent details of the target vulnerability information. For example, the vulnerability details are represented by a character string including the type, target, cause, and the like of vulnerability.

The CVSS vector is information indicating the degree of vulnerability impact and corresponds to a vector representation of a base score defined in CVSS v3. The information indicating the degree of vulnerability impact is not limited to the CVSS vector, and may be information in any other format.

In the example in FIG. 2, the elements separated by the symbol “/” represent “evaluation item: evaluation value” that is a set of each evaluation item of vulnerability and the evaluation value of the evaluation item. For example, “AV:N” indicates that the evaluation value of the evaluation item being attack source classification (attack vector) is “N” representing a network. The other evaluation items are also set according to the evaluation method defined in CVSS v3. The vector representation example in FIG. 2 includes C, I, and A that are evaluation items from the respective viewpoints of confidentiality, integrity, and availability.

The vulnerability type represents the type of target vulnerability. The vulnerability type may be represented, for example, according to common weakness enumeration (CWE) or any other criteria. For example, the vulnerability type may be represented using a unique classification name.

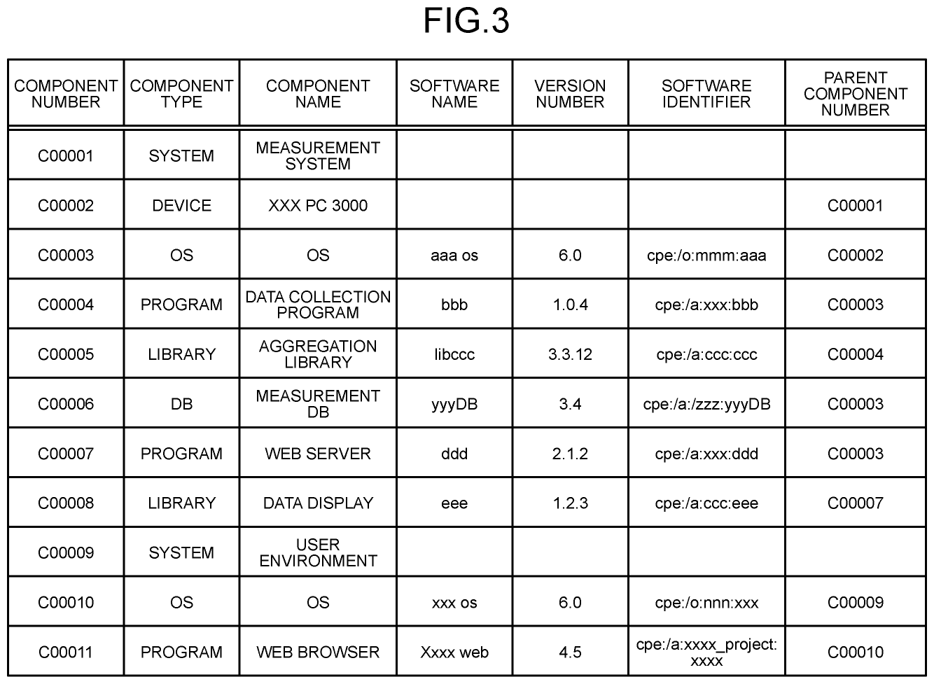

Referring now back to FIG. 1, the component information storage unit 122 stores component information on target components (software and hardware) included in the target system. FIG. 3 is a diagram illustrating an example of the data structure of the component information.

As illustrated in FIG. 3, the component information includes a component number, a component type, a component name, a software name, a version number, a software identifier, and a parent component number.

The component number is an example of identification information for identifying the component information. For example, the component number is a unique number assigned to each component information (record).

The component type represents the type of component in a relevant record. For example, the component type represents one of the following.
System: Represents a system including a plurality of devices.
Device: Represents the hardware of devices such as personal computers, networking devices, and Internet of things (IoT) devices.
OS: Represents an operating system.
Program: Represents a computer program that can be executed independently.
Library: Represents a library called from a computer program.
Module: Represents drivers and extension modules called from an OS.
Database: Represents a database management system (DBMS).

The component name represents the set function name of software and hardware included in the system. The software name represents the name of the software. The version number represents the version of the software included in the system.

The software identifier is an identifier of the software included in the system. The software identifier included in the component information is represented, for example, in the same format as the software identifier stored in the vulnerability information storage unit 121.

When the component of a record is not software, the values of the software name, version number, and software identifier fields are left blank.

The parent component number represents the component number of another component including the component of the record. For example, when the component of the record is an OS, the component number of a device installed with the OS is set to the parent component number of the record.

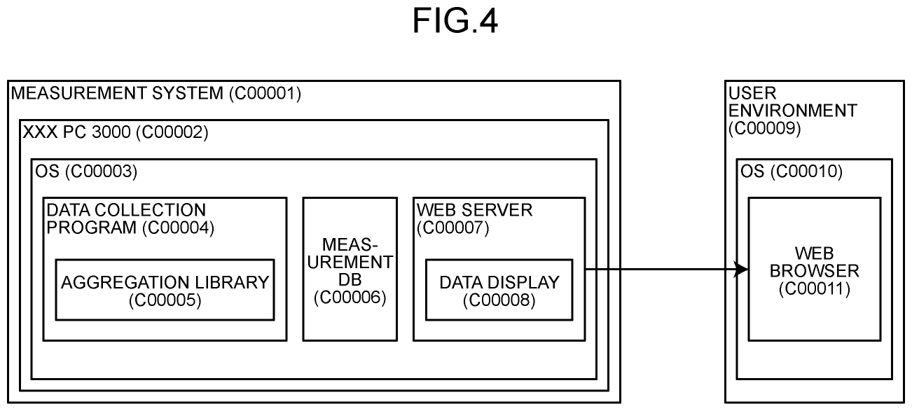

In this way, the component information is information also representing the relationship between a plurality of components. FIG. 4 is a diagram schematically illustrating the relationship between a plurality of components. FIG. 4 corresponds to a diagram illustrating the relationship between the components indicated by the component information in FIG. 3.

Referring now back to FIG. 1, the assessment information storage unit 123 stores assessment information that is the result of risk assessment for the target system. The risk assessment may be performed using any method, for example, according to the assessment method disclosed in Information-technology Promotion Agency, Japan, Security Risk Analysis Guide for Security Center Control Systems, Second Edition, p.137 to p.138, March 2020 or Information-technology Promotion Agency, Japan, Information Security Measures Guidelines for Small and Medium Enterprises, Version 3.1, p.54 to p.56, April 2023.

The assessment information resulting from the risk assessment is assumed to include at least the following information.
Protected asset name: Name of an asset to be protected (protected asset and information asset) included in the system.
Storage location: Location where the protected asset is stored (where the protected asset exists) on the system. For example, the storage location is represented by the component numbers of one or more of components including the protected asset.
Degree of impact: Degree of impact on vulnerabilities in the protected asset.

In this way, the assessment information corresponds to information that associates at least some of a plurality of target components, one or more of assets included in the target system, and the degree of impact when the one or more of assets are attacked.

Although a single degree of impact may be defined for the protected asset, the degree of impact may be defined for each of the viewpoints of confidentiality, integrity, and availability. This makes it possible to more accurately obtain the degree of impact on vulnerabilities for each protected asset. Note that, depending on the assessment method, the degree of impact may be referred to as the degree of importance or an evaluation value.

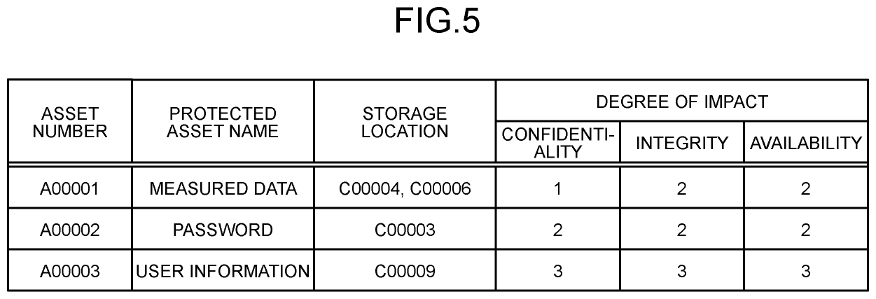

FIG. 5 is a diagram illustrating an example of the data structure of the assessment information. As illustrated in FIG. 5, the assessment information includes an asset number, a protected asset name, a storage location, and the degree of impact. FIG. 5 is an example of assessment information where the degree of impact is defined for each of confidentiality, integrity and availability.

The asset number is an example of identification information for identifying the protected asset. For example, the asset number is a unique number assigned to each assessment information (record).

The protected asset name represents the name of the protected asset. The storage location represents a component where a corresponding protected asset is stored or exists. For example, the storage location is represented by the component number of the component.

The degree of impact represents the degree of impact when a corresponding protected asset is attacked, by “confidentiality”, “integrity”, and “availability”. For example, the degree of impact is set according to the criteria in Table. 12 of Information-technology Promotion Agency, Japan, Information Security Measures Guidelines for Small and Medium Enterprises, Version 3.1, p.54 to p. 56, April 2023.

The assessment information in FIG. 5 is an example of assessment information including only items used in the present embodiment, and is not limited thereto. The assessment information may include other items depending on an assessment method applied.

Each of the storage units (the vulnerability information storage unit 121, the component information storage unit 122, and the assessment information storage unit 123) can be composed of any commonly used storage media such as a flash memory, a memory card, a random access memory (RAM), a hard disk drive (HDD), and an optical disk.

The storage units may be physically different storage media or may be implemented as different storage areas of the same physical storage medium. Each storage unit may also be implemented by a plurality of physically different storage media.

Referring now back to FIG. 1, the reception module 101 receives various information used in the information processing device 100. For example, the reception module 101 receives vulnerability information from the server 300 via the network 400. The reception module 101 may receive vulnerability information stored in the storage medium from a storage medium such as a CD-ROM, for example. The reception module 101 stores the received vulnerability information in the vulnerability information storage unit 121, for example.

The detection module 111 detects, from a plurality of target components included in a target system, one or more of components CA (first components) affected by vulnerabilities included in the target system. The detection module 111 includes a component specifying module 112.

The component specifying module 112 first detects one or more of vulnerable components CB from the plurality of target components. Subsequently, the component specifying module 112 specifies one or more of components affected by vulnerabilities in the detected component CB from the plurality of target components, and outputs the specified components as the components CA. One or more of the components affected by the vulnerabilities in the component CB include the component CB itself.

For example, the component specifying module 112 specifies, as the components CA, one or more of the components affected by the vulnerabilities in the detected component CB, depending on the type of the detected component CB.

In this way, in the present embodiment, the component CA is detected, including not only the component CB detected as a vulnerable component but also other components affected by the vulnerabilities in the component CB. Such a process by the component specifying module 112 can also be interpreted as a process of specifying the range (affected range) of components affected by the vulnerabilities.

The process of including other components affected by the vulnerabilities in the component CB may not be performed, that is, only the component CB may be configured to be output as the component CA.

Although any method for detecting one or more of vulnerable components CB from the plurality of target components can be used, for example, the method disclosed in Information-technology Promotion Agency, Japan, Information Security Measures Guidelines for Small and Medium Enterprises, Version 3.1, p.54 to p.56, April 2023 above can be applied. In this method, vulnerable components are detected by determining the relationship between pre-registered configuration information and stored vulnerability information.

The configuration information is, for example, information including software and version information for a plurality of pieces of software installed on the target system. For example, the component information stored in the component information storage unit 122 can be used as the configuration information. Configuration information defined separately from the component information may also be used. For example, the vulnerability information can use the vulnerability information stored in the vulnerability information storage unit 121.

In this way, the detection module 111 (the component specifying module 112) can detect the one or more of vulnerable components from the plurality of target components by using the vulnerability information. For example, the detection module 111 detects the vulnerable components by determining whether software corresponding to the software name and the version information included in the vulnerability information stored in the vulnerability information storage unit 121 exists in the target system. For example, the detection module 111 outputs, as a detection result, the vulnerability ID included in the vulnerability information and the component number of the vulnerable component corresponding to the vulnerability ID.

The detection module 111 (the component specifying module 112) may also detect the vulnerable components without using the vulnerability information. For example, the detection module 111 first detects vulnerabilities in the target system. For example, a method for detecting vulnerabilities in the target system can be used by installing a computer program that discovers vulnerabilities in devices included in the target system and periodically executing the computer program.

When the vulnerabilities in the target system are detected, the detection module 111 further detects one or more of the components having the detected vulnerability. For example, the detection module 111 refers to the component information stored in the component information storage unit 122 and specifies a component where the detected vulnerabilities have occurred.

The asset specifying module 113 uses the assessment information and specifies one or more of assets corresponding to one or more of the components CA detected by the detection module 111.

The evaluation module 114 obtains an evaluation value of damage when the vulnerabilities are attacked, on the basis of the degree of impact corresponding to the one or more of assets specified by the asset specifying module 113. The evaluation value of damage can be interpreted as information representing the degree of damage.

When the assessment information includes the degree of impact of confidentiality, the degree of impact of integrity, and the degree of impact of availability, the evaluation module 114 may obtain a statistical value of the degree of impact of confidentiality, the degree of impact of integrity, and the degree of impact of availability as the evaluation value. The statistical value is, for example, a maximum value of the degree of impact of confidentiality, the degree of impact of integrity, and the degree of impact of availability. The statistical value is not limited to the maximum value, and may also be a total sum (cumulative value) or the like.

The output control module 115 controls the output of various information used by the information processing device 100. For example, the output control module 115 outputs the evaluation value of damage obtained by the evaluation module 114. The output control module 115 may output the evaluation value of damage obtained for one vulnerability, or output evaluation values of damage for a plurality of vulnerabilities together with information indicating the vulnerability (for example, vulnerability ID). The output control module 115 may use any method for outputting the information; for example, a method for outputting (displaying) a screen including the information on a display device and a method for outputting the information in the form of a file such as a comma separated values (CSV) format.

Each of the above units (the reception module 101, the detection module 111, the asset specifying module 113, the evaluation module 114, and the output control module 115) is implemented by one or more processors, for example. For example, each of the above units may be implemented by causing a processor such as a central processing unit (CPU) and a graphics processing unit (GPU) to execute a computer program, that is, by software. Each of the above units may also be implemented by a processor such as a dedicated integrated circuit (IC), that is, by hardware. Each of the above units may also be implemented using a combination of software and hardware. When a plurality of processors are used, each processor may implement one of the units or two or more of the units.

The information processing device 100 may also be physically configured by one device, or may also be physically configured by a plurality of devices. For example, the information processing device 100 may also be constructed on a cloud environment. The units in the information processing device 100 may also be distributed and provided in a plurality of devices.

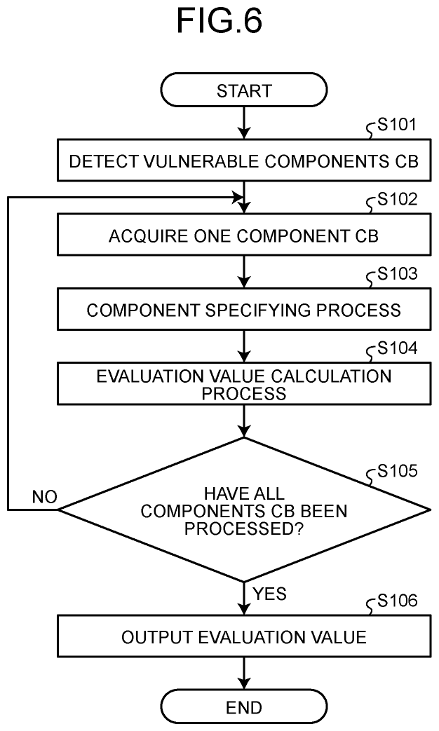

Next, the evaluation process by the information processing device 100 of the first embodiment will be explained. FIG. 6 is a flowchart showing an example of the evaluation process in the first embodiment.

The detection module 111 (the component specifying module 112) detects the vulnerable components CB from the target system (step S101). For example, the detection module 111 outputs a list of one or more component numbers (hereinafter referred to as component list CLB) as a detection result. The component number can be obtained from the component information storage unit 122, for example, as a component number corresponding to a software identifier corresponding to the vulnerability ID stored in the vulnerability information storage unit 121.

When the components CB are detected without using the vulnerability information, the detection module 111 first outputs a list of one or more vulnerability IDs as a detection result. The vulnerability ID is obtained from the vulnerability information stored in the vulnerability information storage unit 121. The detection module 111 specifies a software identifier corresponding to the vulnerability ID in the list by using the vulnerability information stored in the vulnerability information storage unit 121. The detection module 111 also specifies a component number corresponding to the specified software identifier by using the component information stored in the component information storage unit 122.

The following is an example of using the component list CLB. When no component CB is detected (the component list CLB is empty), the evaluation process ends. When one or more of the components CB are detected (when the component list CLB is not empty), the following process is performed.

The component specifying module 112 acquires one component CB from the component list CLB (step S102). The component specifying module 112 performs a component specifying process in order to specify the component CA affected by vulnerabilities in the acquired component CB (step S103). Details of the component specifying process will be explained below.

Subsequently, by using the component CA specified by the component specifying process, the evaluation value calculation process is performed to obtain the evaluation value of damage when vulnerabilities included in the target system are attacked (step S104). Details of the evaluation value calculation process will be explained below.

The detection module 111 determines whether all components CB in the component list CLB have been processed (step S105). When all the components CB have not been processed (No at step S105), the process returns to step S102 and is repeated for the next component CB.

When all the components CB have been processed (Yes at step S105), the output control module 115 outputs an evaluation value on the basis of the result obtained in the evaluation value calculation process (evaluation value list) (step S106) and ends the evaluation process.

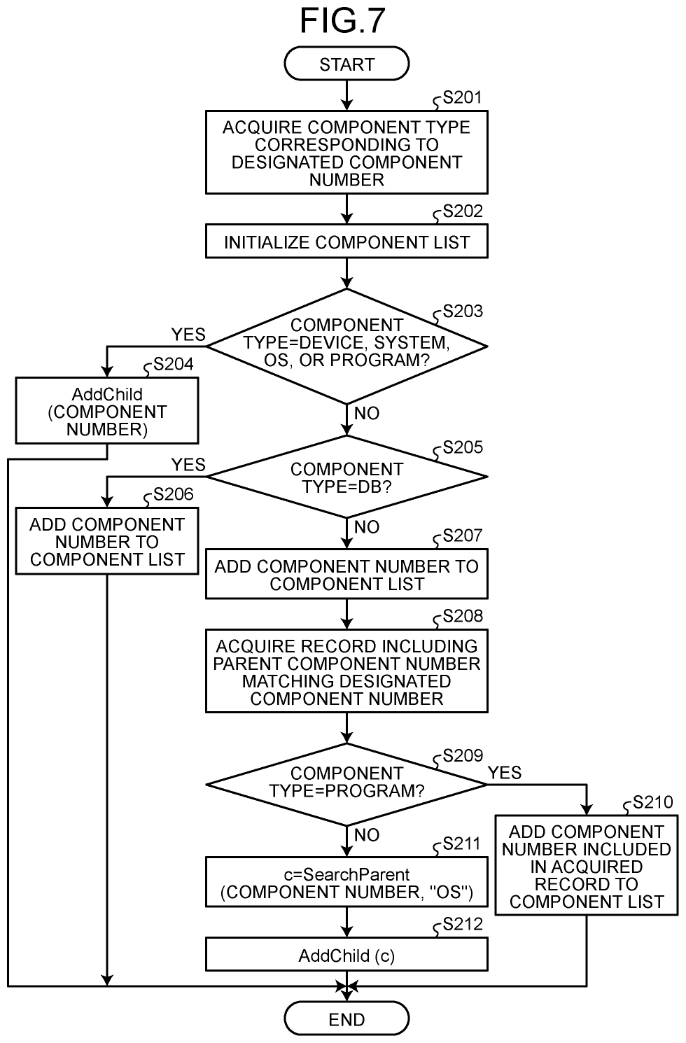

Next, details of the component specifying process at step S103 will be explained. FIG. 7 is a flowchart showing an example of the component specifying process.

In the component specifying process, a component number is passed and the component CA affected by vulnerabilities in the component CB identified by the component number is specified. For example, the component specifying module 112 outputs a list of one or more component numbers (hereinafter referred to as component list CLA) as a specifying result.

The component specifying module 112 searches for a record with a matching designated component number from the component information stored in the component information storage unit 122, and acquires a component type included in the searched record (step S201).

The component specifying module 112 initializes the component list CLA to empty (step S202). Hereinafter, the process branches depending on the component type acquired at step S201.

First, the component specifying module 112 determines whether the component type is “device”, “system”, “OS”, or “program” (step S203). When the component type is “device”, “system”, “OS”, or “program” (Yes at step S203), the component specifying module 112 executes a subroutine AddChild (step S204), and ends the component specifying process.

The AddChild is executed with the component number as an argument, for example. The AddChild is a subroutine for adding, to the component list CLA, other components (child components) included in a component with a component number designated as an argument. Details of the AddChild will be explained below.

When the component type is not “device”, “system”, “OS”, or “program” (No at step S203), the component specifying module 112 determines whether the component type is “DB” (step S205).

When the component type is “DB” (Yes at step S205), the component specifying module 112 adds the designated component number to the component list CLA (step S206), and ends the component specifying process. In this way, when the component type of the designated component CB is “DB”, only the component CB is specified as a component affected by vulnerabilities and no other components are added.

When the component type is not “DB” (No at step S205), that is, when the component type is “library”, the component specifying module 112 adds the designated component number to the component list CLA (step S207). The component specifying module 112 acquires a record including a parent component number matching the designated component number from the component information stored in the component information storage unit 122 (step S208).

The component specifying module 112 determines whether the component type of the acquired record is “program” (step S209). When the component type is “program” (Yes at step S209), the component specifying module 112 adds the component number included in the record to the component list CLA (step S210) and ends the component specifying process.

When the component type is not “program” (No at step S209), the component specifying module 112 executes a subroutine SearchParent (step S211).

The SearchParent is executed, for example, with the component number and the component type as arguments. The SearchParent is a subroutine that searches for a component with the component type designated as an argument among components including the component with the component number designated as an argument. Details of the SearchParent will be explained below.

In the present embodiment, the component number of the component CB is designated as the component number, and “OS” is designated as the component type. The SearchParent outputs the component number of the searched component as a return value. In the following, the component number output by the SearchParent is represented as c.

After the SearchParent is executed, the component specifying module 112 executes the AddChild with the component number c as an argument (step S212), and ends the component specifying process.

The process when the component type of the component CB is “library” (step S207 to step S212) means that when the parent component of the component CB is a computer program, the component CB and the parent component belong to the affected range, and when the parent component is not a computer program, all components included in an OS including the component CB belong to the affected range.

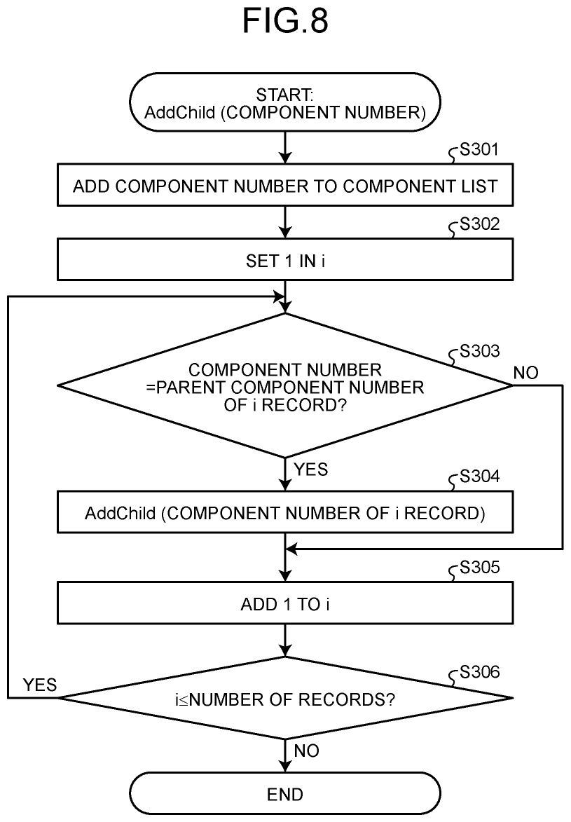

Next, details of the subroutine AddChild will be explained. FIG. 8 is a flowchart showing an example of the AddChild.

The AddChild corresponds to the process of adding, to the component list CLA, the component identified by the component number designated as the argument and all components included in the component.

The component specifying module 112 adds the component number designated as the argument to the component list CLA (step S301). The component specifying module 112 sets 1 in a variable i as an initial value (step S302).

The component specifying module 112 determines whether the component number designated as the argument matches the parent component number of an i^{th} record (hereinafter referred to as i record) in the component information storage unit 122 (step S303).

When the component number matches the parent component number (Yes at step S303), the component specifying module 112 executes the AddChild with the component number of the i record as an argument (step S304). This makes it possible to recursively search for other components (child components) included in the component with the component number designated as the argument.

After executing the AddChild at step S304 or when the component number is determined not to match the parent component number at step S303 (No at step S303), the component specifying module 112 adds 1 to the variable i (step S305). The component specifying module 112 determines whether the value of the variable i is equal to or less than the number of records of the component information stored in the component information storage unit 122 (step S306).

When the variable i is equal to or less than the number of records (Yes at step S306), the process returns to step S303 and is repeated. When the variable i exceeds the number of records (No at step S306), the AddChild ends.

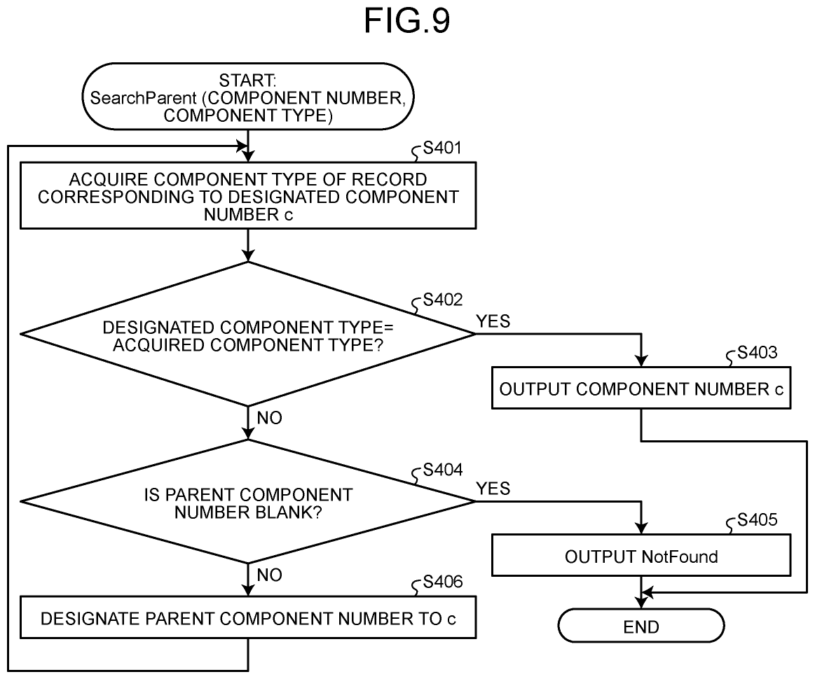

Next, details of the subroutine SearchParent will be explained. FIG. 9 is a flowchart showing an example of the SearchParent.

The component specifying module 112 acquires the component type of the record corresponding to the component number c designated as the argument from the component information stored in the component information storage unit 122 (step S401).

The component specifying module 112 determines whether the acquired component type matches the component type designated as the argument (step S402). When the acquired component type matches the component type (Yes at step S402), since a component of a target component type is found, the component specifying module 112 outputs the value of the component number c as a return value (step S403) and ends the SearchParent.

When the acquired component type does not match the component type (No at step S402), the component specifying module 112 determines whether the parent component number of the acquired record is blank (step S404). When the parent component number of the acquired record is blank (Yes at step S404), since no higher-level component (parent component) exists, the component specifying module 112 outputs information (for example, “NotFound”) indicating that the component of the target component type is not found (step S405), and ends the SearchParent.

When the parent component number of the acquired record is not blank (No at step S404), the component specifying module 112 designates the parent component number of the record as a new component number c (step S406) and returns to step S401 to repeat the process.

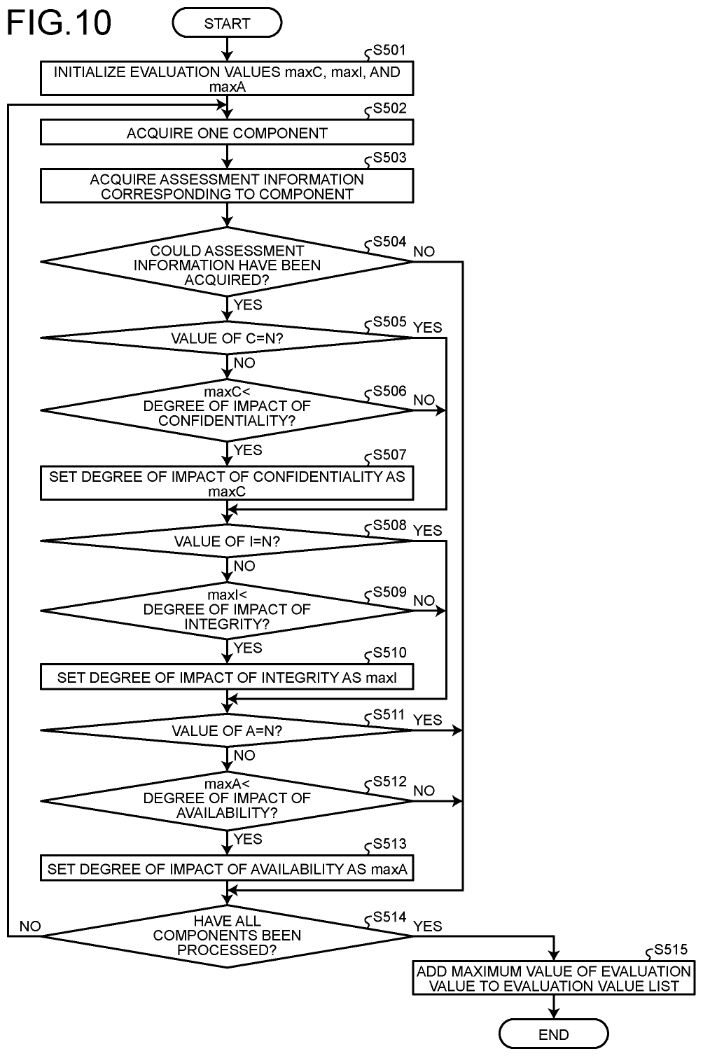

Next, details of the evaluation value calculation process at step S104 will be explained. FIG. 10 is a flowchart showing an example of the evaluation value calculation process.

The evaluation module 114 initializes variables maxC, maxI, and maxA indicating evaluation values to 0 (step S501). The maxC is an evaluation value representing the maximum value of damage related to confidentiality. The maxI is an evaluation value representing the maximum value of damage related to integrity. The maxA is an evaluation value representing the maximum value of damage related to availability.

The asset specifying module 113 acquires one component (component number) from the component list CLA (step S502). The asset specifying module 113 acquires an asset corresponding to the acquired component number from the assessment information stored in the assessment information storage unit 123 (step S503). For example, the asset specifying module 113 acquires assessment information (hereinafter referred to as “record RA”) including the acquired component number in a storage location from the assessment information stored in the assessment information storage unit 123.

The asset specifying module 113 determines whether the assessment information (record RA) could have been acquired (step S504). When the assessment information could have been acquired (Yes at step S504), the evaluation module 114 refers to vulnerability information (the vulnerability information stored in the vulnerability information storage unit 121) corresponding to vulnerabilities in the currently targeted component CB (the component acquired at step S102 in FIG. 6), and determines whether the value of C (confidentiality) of a CVSS vector is N (no impact) (step S505).

When the value of C is not N (No at step S505), the evaluation module 114 determines whether the current value of the maxC is smaller than the value of the degree of impact of confidentiality of the record RA (step S506). When the current value of the maxC is small (Yes at step S506), the evaluation module 114 sets the value of the degree of impact of confidentiality of the record RA as the value of the maxC (step S507).

After setting the value of the maxC, or when the value of C is determined to be N at step S505 (Yes at step S505) or when the value of the maxC is determined to be equal to or greater than the value of the degree of impact of confidentiality at step S506 (No at step S506), the evaluation module 114 performs the same process for the maxI.

That is, the evaluation module 114 determines whether the value of I (integrity) of the CVSS vector is N (no impact) (step S508). When the value of I is not N (No at step S508), the evaluation module 114 determines whether the current value of the maxI is smaller than the value of the degree of impact of integrity of the record RA (step S509). When the current value of the maxI is small (Yes at step S509), the evaluation module 114 sets the value of the degree of impact of integrity of the record RA as the value of the maxI (step S510).

After setting the value of the maxI, or when the value of I is determined to be N at step S508 (Yes at step S508) or when the value of the maxI is determined to be equal to or greater than the value of the degree of impact of integrity at step S509 (No at step S509), the evaluation module 114 performs the same process for the maxA.

That is, the evaluation module 114 determines whether the value of A (availability) of the CVSS vector is N (no impact) (step S511). When the value of A is not N (No at step S511), the evaluation module 114 determines whether the current value of the maxA is smaller than the value of the degree of impact of availability of the record RA (step S512). When the current value of the maxA is small (Yes at step S512), the evaluation module 114 sets the value of the degree of impact of availability of the record RA as the value of the maxA (step S513).

After setting the value of the maxA, or when the value of I is determined to be N at step S511 (Yes at step S511), when the value of the maxA is determined to be equal to or greater than the value of the degree of impact of availability at step S512 (No at step S512), or when the assessment information is determined to have been acquirable at step S504 (No at step S504), the evaluation module 114 determines whether all the components included in the component list CLA have been processed (step S514).

When all the components have not been processed (No at step S514), the process returns to step S502 and is repeated for the next component.

When all the components have been processed (Yes at step S514), the evaluation module 114 adds, to the evaluation value list, a set of the vulnerability ID of the vulnerability information corresponding to the vulnerabilities in the currently targeted component CB and a statistical value (for example, a maximum value) of the maxC, the maxI, and the maxA (Step S515) and ends the evaluation value calculation process. The evaluation value list is assumed to be initialized, for example, at the start of the evaluation process (FIG. 6).

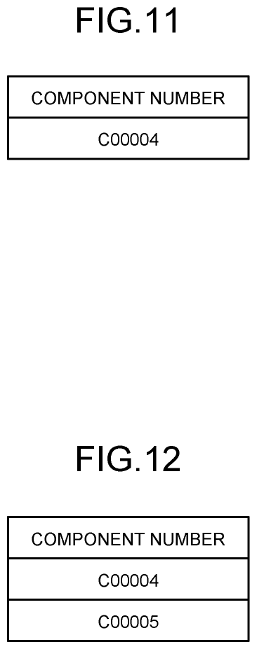

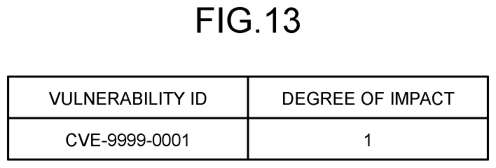

Next, specific examples of the evaluation process by the information processing device 100 of the present embodiment will be explained with reference to FIGS. 11 to 13, in addition to the drawings explained so far. FIG. 11 is a diagram illustrating an example of the component list CLB. FIG. 12 is a diagram illustrating an example of the component list CLA obtained based on the component list CLB in FIG. 11. FIG. 13 is a diagram illustrating an example of an evaluation value that is output.

As illustrated in FIG. 11, a component with a component number “C00004” is assumed to be detected as a vulnerable component (step S101 in FIG. 6). The component with the component number “C00004” is detected as a component corresponding to software with a software identifier “cpe:/a:xxx:bbb” corresponding to a vulnerability ID “CVE-9999-0001”.

The detection module 111 (the component specifying module 112) extracts the component number “C00004” of the component CB from the component list CLB because the component list CLB is not empty (step S102 in FIG. 6).

Subsequently, the component specifying process (step S103 in FIG. 6, and FIG. 7) is performed by the component specifying module 112.

The component specifying module 112 refers to the component information as illustrated in FIG. 3, for example, and acquires a component type “program” corresponding to the acquired component number “C00004” (step S201 in FIG. 7). The component specifying module 112 initializes the component list CLA to empty (step S202).

Since the component type is “program” (Yes at step S203), the component specifying module 112 calls AddChild (FIG. 8) with the component number “C00004” as an argument (step S204).

The component specifying module 112 adds the component number “C00004” designated as the argument to the component list CLA (step S301), and sets 1 in the variable i (step S302).

The component specifying module 112 compares the parent component number of the i record (first record) with “C00004” being the argument of the AddChild (step S303). Since the parent component number of the first record is empty in the component information of FIG. 3, the parent component number is determined not to match “C00004” (No at step S303). Therefore, the component specifying module 112 adds 1 to the variable i (step S305), and determines whether the value of the variable i is equal to or less than the number (11 in the example in FIG. 3) of records of the component information (step S306). Since the value 2 of the variable i is equal to or less than 11, the process returns to step S303 and is repeated.

When the variable i is 5, the parent component number “C00004” of record 5 (fifth record) is determined to match “C00004” being the argument of the AddChild at step S303. Therefore, the component specifying module 112 calls the AddChild with a component number “C00005” of the record 5 as an argument (step S304).

In this call, “C00005” is added to the component list CLA at step S301. Since no record with the parent component number “C00005” exist in the component information, the AddChild is not called further and ends.

After step S204 in FIG. 7, the component specifying process ends. That is, step S103 in FIG. 6 also ends. At this point, the component list CLA includes C00004 and C00005. FIG. 12 is a diagram illustrating an example of the component list CLA obtained in this way.

Subsequently, the evaluation value calculation process (step S104 in FIG. 6, and FIG. 10) is performed. The evaluation module 114 initializes the values of the maxC, the maxI, and the maxA to 0 (step S501). Since the component list CLA is not empty, the asset specifying module 113 acquires one component number “C00004” from the component list CLA (step S502). The asset specifying module 113 searches for a record including “C00004” in the storage location of the assessment information. For the assessment information in FIG. 5, a record with an asset number “A00001” is searched as the record.

The evaluation module 114 refers to a CVSS vector “AV:N/AC:L/PR:L/UI:N/S:C/C:H/I:N/A:N” corresponding to a vulnerability ID “CVE-9999-0001” in the vulnerability information illustrated in FIG. 2, for example, and determines that the value of “C” is “H”, that is, is not “N” (No at step S505). The evaluation module 114 compares the value 1 of confidentiality of the record with the asset number “A00001” in the assessment information with the maxC (0 at this point) (step S506). Since the maxC is small (Yes at step S506), the evaluation module 114 puts the value 1 of confidentiality of the record to the maxC (step S507).

Since the value of “I” is “N” (Yes at step S508) and the value of “A” is “N” (Yes at step S511), the values of the maxI and the maxA are not updated.

The evaluation module 114 determines whether all the components have been processed (step S514), and determines that the component number “C00005” has not been processed (No at step S514). For the component number “C00005”, the evaluation module 114 determines the absence of the record including “C00005” in the storage location of the assessment information (No at step S504).

Subsequently, the evaluation module 114 determines that all the components have been processed (Yes at step S514), and the evaluation module 114 adds an evaluation value to the evaluation value list (step S515). For example, the evaluation module 114 adds 1 to the evaluation value list as an evaluation value for the vulnerability ID CVE-9999-0001, 1 being a maximum value among maxC=1, maxI=0, and maxA=0.

At step S105 of FIG. 6, all the components CB (component number “C00004”) are determined to have been processed, and the output control module 115 outputs the evaluation value (step S106) and ends the evaluation process. FIG. 13 is a diagram illustrating an example of the output of the evaluation value (degree of impact) by the output control module 115. In this example, only the evaluation value for the vulnerability ID “CVE-9999-0001” is output.

In this way, the information processing device of the first embodiment evaluates the impact when vulnerabilities in the system are attacked by using the result (assessment information) of the risk assessment for the target system. This makes it possible to more efficiently evaluate the impact when the vulnerabilities in the system are attacked.

### Second Embodiment

An information processing device of the second embodiment has a function of modifying the component CA obtained as a result of the component specifying process, in other words, the range (affected range) of components affected by vulnerabilities.

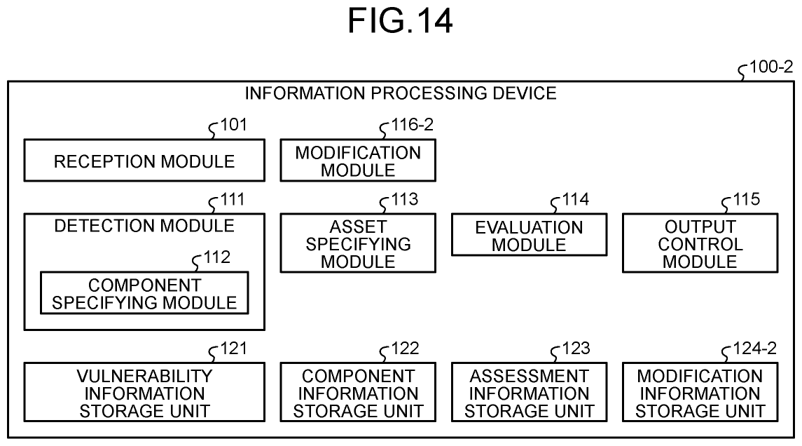

FIG. 14 is a block diagram illustrating an example of the configuration of an information processing device 100-2 of the second embodiment. As illustrated in FIG. 14, the information processing device 100-2 includes the vulnerability information storage unit 121, the component information storage unit 122, the assessment information storage unit 123, a modification information storage unit 124-2, the reception module 101, the detection module 111, the asset specifying module 113, the evaluation module 114, the output control module 115, and a modification module 116-2.

The second embodiment differs from the first embodiment in that the modification information storage unit 124-2 and the modification module 116-2 are added. Since the other configurations and functions are the same as in FIG. 1 being a block diagram of the information processing device 100 of the first embodiment, the same numerals are assigned and descriptions thereof are omitted.

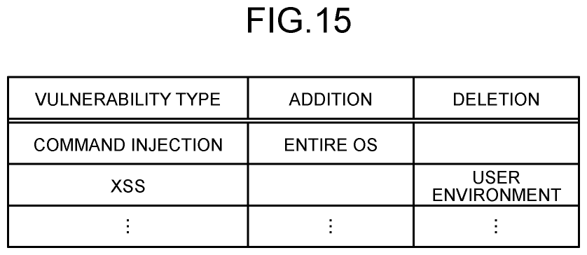

The modification information storage unit 124-2 stores modification information that is referred to when modifying the affected range. The modification information corresponds to a modification rule for modifying the component CA obtained by the component specifying module 112 for each vulnerability type. FIG. 15 is a diagram illustrating an example of the data structure of the modification information.

As illustrated in FIG. 15, the modification information includes three fields: vulnerability type, addition, and deletion. The vulnerability type represents the type of vulnerability to which the modification rule applies and is expressed in the same way as the vulnerability type in the vulnerability information storage unit 121. The addition represents an affected range including a component to be added. The deletion represents an affected range including a component to be deleted. When both the addition and the deletion are designated, the addition takes precedence and an affected range to which a component listed in an addition field is added is assumed not to be affected by the deletion. Designations by the addition and the deletion may be considered as follows.

Entire OS: Entire OS to which a component belongs.

DB: Entire DB to which the component belongs. Not applicable when the component does not belong to DB.

API (Application Programming Interface): Range of access for WebAPI.

User environment: Environment used by users of target system.

The modification module 116-2 performs at least one of addition of components to the component CA and deletion of components from the component CA by using the modification information stored in the modification information storage unit 124-2. For example, the modification module 116-2 acquires a record with the vulnerability ID of a specified vulnerability from the vulnerability information storage unit 121, and acquires a vulnerability type included in the acquired record. The modification module 116-2 acquires a record of the modification information corresponding to the acquired vulnerability type from the modification information storage unit 124-2, and modifies the component CA according to the description of addition or deletion included in the acquired record.

The modification module 116-2 may further have a function of modifying the component CA by referring to a CVSS vector corresponding to the vulnerability ID. For example, the modification module 116-2 can also acquire the record with the vulnerability ID of the specified vulnerability from the vulnerability information storage unit 121, and when “S (Scope)” of a CVSS vector in the acquired record is “C (with changes)”, extend an affected range to the entire target system.

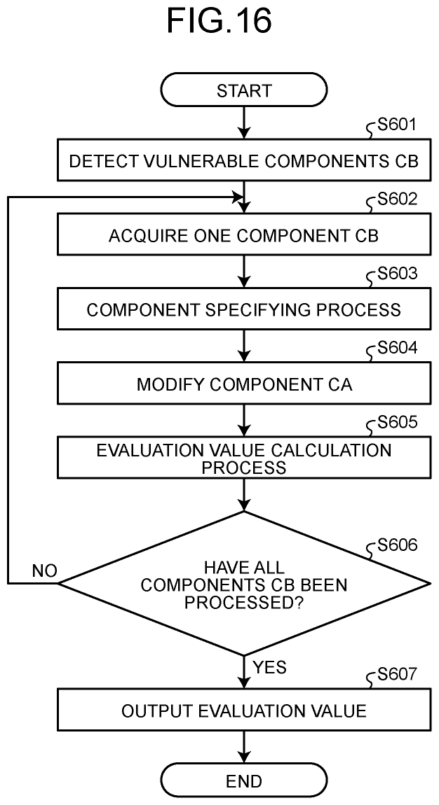

Next, an evaluation process by the information processing device 100-2 of the second embodiment will be explained with reference to FIG. 16. FIG. 16 is a flowchart showing an example of the evaluation process in the second embodiment.

In the present embodiment, after the component specifying process, step S604 is added as a process of modifying the component CA (affected range) obtained by the component specifying process.

Since steps S601 to S603 are the same as steps S101 to S103 in the information processing device 100 of the first embodiment, descriptions thereof are omitted.

At step SS604, the modification module 116-2 modifies the component CA obtained by the component specifying process, according to the modification information stored in the modification information storage unit 124-2.

Since steps S605 to S607 are the same as steps S104 to S106 in the information processing device 100 of the first embodiment, descriptions thereof are omitted.

In this way, in the second embodiment, the range (affected range) of components affected by vulnerabilities can be modified. Therefore, the impact when vulnerabilities in the system are attacked can be more accurately evaluated.

As explained above, according to the first and second embodiments, the impact when vulnerabilities in the system are attacked can be more efficiently evaluated.

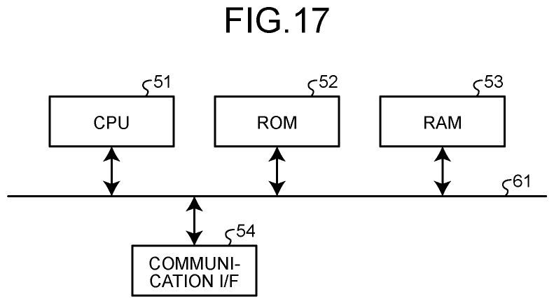

Next, the hardware configuration of the information processing device of the first or second embodiment will be explained with reference to FIG. 17. FIG. 17 is an explanatory diagram illustrating an example of the hardware configuration of the information processing device of the first or second embodiment.

The information processing device of the first or second embodiment includes a control device such as a CPU 51, a storage device such as a read only memory (ROM) 52 and a RAM 53, a communication I/F 54 that connects to a network for communication, and a bus 61 that connects each part.

A computer program to be executed by the information processing device of the first or second embodiment is provided by being pre-embedded in the ROM 52 or the like.

The computer program to be executed by the information processing device of the first or second embodiment may be configured to be provided as a computer program product by being recorded on a computer readable storage medium, such as a compact disc read only memory (CD-ROM), a flexible disk (FD), and a CD-R (compact disc recordable), and a digital versatile disc (DVD), as a file in an installable format or an executable format.

Moreover, the computer program to be executed by the information processing device of the first or second embodiment may also be configured to be provided by being stored on a computer connected to a network such as the Internet and downloaded via the network. The computer program executed by the information processing device of the first or second embodiment may also be configured to be provided or distributed via the network such as the Internet.

The computer program executed by the information processing device of the first or second embodiment can cause a computer to serve as each part of the information processing device explained above. The computer can execute the computer program that is read on a main storage device by the CPU 51 from the computer readable storage medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more processors configured to:
detect, from a plurality of target components included in an information processing system to be evaluated, one or more of first components affected by a vulnerability included in the information processing system;
specify, by using assessment information that associates at least some of the plurality of target components, one or more of assets included in the information processing system, and a degree of impact when the one or more of the assets are attacked, the one or more of the assets corresponding to the detected one or more of the first components; and
obtain an evaluation value of damage when the vulnerability is attacked, based on the degree of impact corresponding to the specified one or more of the assets.

2. The device according to claim 1, wherein
the degree of impact includes a degree of impact of confidentiality, a degree of impact of integrity, and a degree of impact of availability, and
the one or more processors are configured to obtain, as the evaluation value, a statistical value of the degree of impact of confidentiality, the degree of impact of integrity, and the degree of impact of availability.

3. The device according to claim 2, wherein the statistical value includes a maximum value of the degree of impact of confidentiality, the degree of impact of integrity, and the degree of impact of availability.

4. The device according to claim 1, wherein the one or more processors are configured to detect one or more of components having the vulnerability from the plurality of target components, and specify one or more of the first components affected by the vulnerability in the detected one or more of components from the plurality of target components.

5. The device according to claim 4, wherein the one or more processors are configured to perform at least one of addition of a component to the one or more of the first components and deletion of a component from the one or more of the first components by using modification information for defining a component to be added or deleted for each type of vulnerability.

6. The device according to claim 4, wherein the one or more processors are configured to specify the one or more of the first components affected by the vulnerability in the detected one or more of components, depending on a type of the detected one or more of components.

7. The device according to claim 1, wherein the one or more processors are configured to detect, by using vulnerability information indicating the vulnerability in one or more of components, the one or more of the first components from the plurality of target components.

8. The device according to claim 1, wherein the one or more processors are configured to detect the vulnerability in the information processing system, and detect the one or more of the first components having the detected vulnerability.

9. The device according to claim 1, wherein the one or more processors are configured to output the evaluation value.

10. An information processing method performed by an information processing device, the method comprising:
detecting, from a plurality of target components included in an information processing system to be evaluated, one or more of first components affected by a vulnerability included in the information processing system;
specifying, by using assessment information that associates at least some of the plurality of target components, one or more of assets included in the information processing system, and a degree of impact when the one or more of the assets are attacked, the one or more of the assets corresponding to the detected one or more of the first components; and
obtaining an evaluation value of damage when the vulnerability is attacked, based on the degree of impact corresponding to the specified one or more of the assets.

11. A computer program product comprising a non-transitory computer-readable medium including programmed instructions, the instructions causing a computer to execute:
detecting, from a plurality of target components included in an information processing system to be evaluated, one or more of first components affected by a vulnerability included in the information processing system;
specifying, by using assessment information that associates at least some of the plurality of target components, one or more of assets included in the information processing system, and a degree of impact when the one or more of the assets are attacked, the one or more of the assets corresponding to the detected one or more of the first components; and
obtaining an evaluation value of damage when the vulnerability is attacked, based on the degree of impact corresponding to the specified one or more of the assets.
